(19) United States
(12) Patent Application Publication
(10) Pub. No.: US 2010/0079424 A1
(43) Pub. Date: Apr. 1, 2010

(54) DISPLAY MEDIUM AND DISPLAY

(75) Inventors: Shih-Kang Fan, Hsinchu City (TW); Cheng-Pu Chiu, Taipei County (TW); Ching-Hsiang Hsu, Hsinchu City (TW); Mei-Tsao Chiang, Taoyuan County (TW); Chi-Neng Mo, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/356,549

(22) Filed: Jan. 21, 2009

(30) Foreign Application Priority Data
Oct. 1, 2008 (TW) 97137763

(51) Int. Cl. G09G 5/00; B01J 13/00

(52) U.S. Cl. 345/206; 516/98; 516/99

(57) ABSTRACT

A display medium and a display are provided. The display medium includes a thermal-sensitive solution and a number of micro particles. The micro particles are dispersed in the thermal-sensitive solution. At a first temperature, the thermal-sensitive solution is in a liquid form, such that the micro particles move freely. At a second temperature, the thermal-sensitive solution is in a colloid form, such that the micro particles are fixed. The first temperature differs from the second temperature.

### CROSS-REFERENCE TO RELATED APPLICATION

This application claims the priority benefit of Taiwan application serial no. 97137763, filed Oct. 1, 2008. The entirety of the above-mentioned patent application is hereby incorporated by reference herein and made a part of specification.

### BACKGROUND OF THE INVENTION

1. Field of the Invention

The present invention relates to a display medium and a display. More particularly, the present invention relates to a multi-stable display medium and a display.

2. Description of Related Art

Electronic paper display technology was first developed in 1970s and characterized by small balls equipped with electric charges. One side of the balls is white, and the other side is black. When an electric field is changed, the balls are rotated upwardly or downwardly to exhibit different colors. The second-generation electronic paper display technology was developed in 1990s and characterized by microcapsules filled with color oil and charged white particles in replacement of the conventional small balls. By controlling an external electric field, the charged white particles are moved upwardly or downwardly. When the charged white particles are moved upwardly (in a direction approaching a user), the white color of the particles is exhibited. By contrast, when the charged white particles are moved downwardly (in a direction away from the user), the color of the oil is exhibited.

These conventional technologies can achieve the purpose of display because the charged particles migrate electrophoretically. Furthermore, common electronic paper display technologies further include electronic powder, charged polymer particles, cholesteric liquid crystals, electrowetting technologies, and so on. By applying the electric field, different particles have different mobility rates, and certain particles with relatively high mobility rates are pulled to a viewing side of the display, so as to perform the display function. However, separation of particles by time does not contribute to stable display of images. As such, the electronic paper display technology still faces the issue of unstable quality of displayed images.

### SUMMARY OF THE INVENTION

Since a conventional display medium applied to displays including electronic paper is not stable, the present invention is directed to a display medium for resolving said issue.

Since quality of displayed images in conventional displays including electronic paper is not stable, the present invention is further directed to a display for resolving said issue.

The present invention provides a display medium including a thermal-sensitive solution and a plurality of micro particles. The micro particles are dispersed in the thermal-sensitive solution. At a first temperature, the thermal-sensitive solution is in a liquid form, such that the micro particles move freely. At a second temperature, the thermal-sensitive solution is in a colloid form, such that the micro particles are fixed. Here, the first temperature differs from the second temperature.

In an embodiment of the present invention, the first temperature is higher than a threshold temperature, while the second temperature is lower than the threshold temperature.

In an embodiment of the present invention, the first temperature is lower than a threshold temperature, while the second temperature is higher than the threshold temperature.

In an embodiment of the present invention, an electric field results in polarization and self-alignment of the plurality of micro particles.

In an embodiment of the present invention, the micro particles include a plurality of first-type micro particles, a plurality of second-type micro particles, and a plurality of third-type micro particles. A first electric field results in polarization and self-alignment of each of the first-type micro particles, a second electric field results in polarization and self-alignment of each of the second-type micro particles, and a third electric field results in polarization and self-alignment of each of the third-type micro particles. Practically, the first electric field, the second electric field, and the third electric field respectively have a first frequency, a second frequency, and a third frequency. The first frequency, the second frequency, and the third frequency differ from one another. To be more specific, the first-type micro particles, the second-type micro particles, and the third-type micro particles respectively have different colors.

In an embodiment of the present invention, a material of the thermal-sensitive solution includes poly N-isopropyl acrylamide (PNIPAAm).

In an embodiment of the present invention, the thermal-sensitive solution is transparent and colorless.

The present invention further provides a display including a first substrate, a first electrode, a second substrate, a second electrode, and a display medium. The first electrode is disposed on the first substrate, and the second electrode is disposed on the second substrate. The display medium is sandwiched between the first electrode and the second electrode. Besides, the display medium includes a thermal-sensitive solution and a plurality of micro particles. The micro particles are dispersed in the thermal-sensitive solution. At a first temperature, the thermal-sensitive solution is in a liquid form, such that the micro particles move freely. At a second temperature, the thermal-sensitive solution is in a colloid form, such that the micro particles are fixed. The first temperature differs from the second temperature.

In an embodiment of the present invention, the first temperature is higher than a threshold temperature, while the second temperature is lower than the threshold temperature.

In an embodiment of the present invention, the first temperature is lower than a threshold temperature, while the second temperature is higher than the threshold temperature.

In an embodiment of the present invention, an electric field generated by the first electrode and the second electrode results in polarization and self-alignment of the micro particles.

In an embodiment of the present invention, the micro particles include a plurality of first-type micro particles, a plurality of second-type micro particles, and a plurality of third-type micro particles. A first electric field generated by the first electrode and the second electrode results in polarization and self-alignment of each of the first-type micro particles. A second electric field generated by the first electrode and the second electrode results in polarization and self-alignment of each of the second-type micro particles. A third electric field generated by the first electrode and the second electrode results in polarization and self-alignment of each of the third-type micro particles. Practically, the first electric field, the second electric field, and the third electric field respectively have a first frequency, a second frequency, and a third frequency. The first frequency, the second frequency, and the third frequency differ from one another. To be more specific, the first-type micro particles, the second-type micro particles, and the third-type micro particles respectively have different colors.

In an embodiment of the present invention, a material of the thermal-sensitive solution includes PNIPAAm.

In an embodiment of the present invention, the thermal-sensitive solution is transparent and colorless.

In an embodiment of the present invention, the first electrode is a reflective electrode.

In an embodiment of the present invention, the second electrode is a transparent electrode.

In an embodiment of the present invention, the micro particles include metal particles.

In an embodiment of the present invention, the micro particles include polymer particles. For instance, a material of the micro particles includes polystyrene particles or polyethylene particles.

According to the present invention, the micro particles are dispersed in the solution which is in different forms as the temperature changes. Thereby, the micro particles in the display medium can be fixed on certain conditions. In other words, the display medium of the present invention can remain stable, and the display of the present invention can be a multi-stable display.

To make the above and other features and advantages of the present invention more comprehensible, several embodiments accompanied with figures are detailed as follows.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1A illustrates a display according to an embodiment of the present invention.

FIG. 1B illustrates a display which is performing a display function according to the present invention.

FIG. 2 is a display according to another embodiment of the present invention.

### DESCRIPTION OF EMBODIMENTS

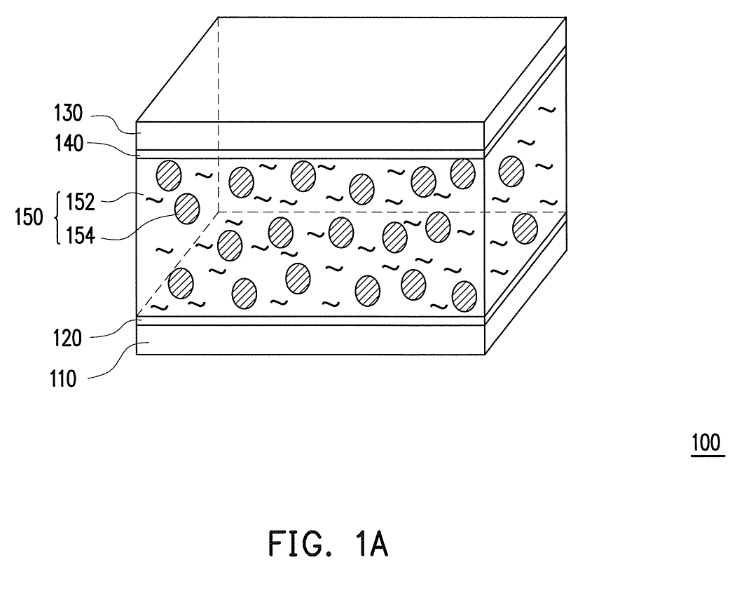

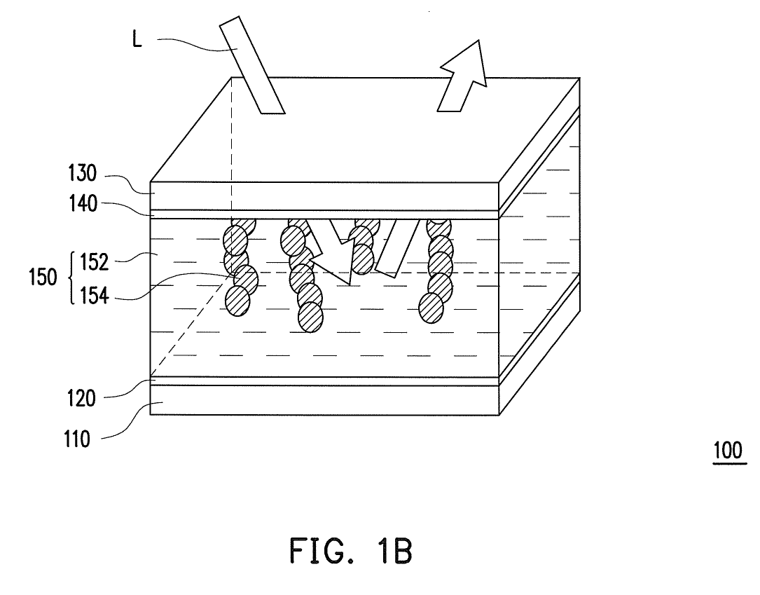

FIG. 1A illustrates a display according to an embodiment of the present invention. Referring to FIG. 1A, a display 100 includes a first substrate 110, a first electrode 120, a second substrate 130, a second electrode 140, and a display medium 150. The first electrode 120 is disposed on the first substrate 110, and the second electrode 140 is disposed on the second substrate 130. The display medium 150 is sandwiched between the first electrode 120 and the second electrode 140. Besides, the display medium 150 includes a thermal-sensitive solution 152 and a plurality of micro particles 154. The micro particles 154 are dispersed in the thermal-sensitive solution 152. In the present embodiment, the first electrode 120 is, for example, a reflective electrode, and the second electrode 140 is, for example, a transparent electrode. Namely, the second substrate 130 serves as a display surface in the present embodiment, which should not be otherwise construed as a limitation to the present invention. In practice, the first electrode 120 can be made of a metal material with high reflectivity, while the second electrode 120 can be made of indium tin oxide (ITO), indium zinc oxide (IZO), or aluminum zinc oxide (AZO).

Moreover, the thermal-sensitive solution 152 of the present embodiment is to some extent sensitive to variations of surrounding temperatures. Hence, at a first temperature, the thermal-sensitive solution 152 is in a liquid form, such that the micro particles 152 can move freely. By contrast, at a second temperature, the thermal-sensitive solution 152 is in a colloid form, and the micro particles 154 are then fixed. That is to say, the thermal-sensitive solution 152 of the present embodiment can be in different forms as the temperature changes.

In detail, when the thermal-sensitive solution 152 is thermopositive, and the temperature of the display medium 150 is higher than a threshold temperature, the thermal-sensitive solution 152 is in the liquid form. If the temperature of the display medium 150 is lower than the threshold temperature, the thermal-sensitive solution 152 is in the colloid form Namely, given that the thermal-sensitive solution 152 is thermopositive, the first temperature is higher than the threshold temperature, while the second temperature is lower than the threshold temperature, for example.

By contrast, when the thermal-sensitive solution 152 is thermonegative, the thermal-sensitive solution 152 performs in a way contrary to those described above. In other words, the first temperature is thus lower than the threshold temperature, while the second temperature is higher than the threshold temperature. As a whole, the first and second temperatures are determined upon characteristics of the thermal-sensitive solution 152. Hence, the first and second temperatures are not specifically defined in the present invention. Certainly, the threshold temperature is also determined upon characteristics of the thermal-sensitive solution 152.

According to the present embodiment, the thermal-sensitive solution 152 includes thermal-sensitive polymer which is made of PNIPAAm, for example. Besides, the thermal-sensitive solution 152 is transparent and colorless. In other words, the display function is performed by means of the micro particles 154 rather than by means of the thermal-sensitive solution 152 in the present embodiment. The micro particles 154 include metal particles or polymer particles. For instance, when the micro particles 154 are the polymer particles, a material of the micro particles 154 includes polystyrene particles or polyethylene particles. A diameter of the micro particles 154 is, for example, three micrometers, which is however not limited in the present invention. In practice, the threshold temperature at which the thermal-sensitive solution 152 is transformed can be determined upon a process of fabricating the thermal-sensitive solution 152. For instance, during the fabrication of the thermal-sensitive solution 152, the threshold temperature can be adjusted by adding certain monomer molecules or certain additives.

In general, the thermal-sensitive solution 152 in the liquid form can be changed to be in the colloid form under some circumstances, such that the micro particles 154 are confined, and the display medium 150 can be stabilized. As a result, images displayed on the display 100 can be rather stable. That is to say, the characteristics of the display medium 150 is conducive to better stabilizing the display quality of the display 100.

FIG. 1B illustrates a display which is performing a display function according to the present invention. Specifically, referring to FIG. 1B, when the display 100 performs the display function, the micro particles 154 are affected by an electric field generated by the first electrode 120 and the second electrode 140, and the micro particles 154 are then polarized and self-aligned. Therefore, the micro particles 154 are orderly arranged in a certain manner. As such, an image can be displayed after an incident light beam L of the first substrate 130 is reflected by the first electrode 120. Note that the thermal-sensitive solution 152 is in the liquid form when the arrangement of the micro particles 154 is affected by the electric field. Thereby, the micro particles 154 can move freely, i.e., the micro particles 154 affected by the electric field can be polarized and arranged in a certain manner.

Thereafter, in order to constantly display the images, it is preferable for the micro particles 154 to maintain in said arrangement. Hence, for instance, in the present embodiment, the micro particles 154 are fixed by adjusting the temperature of the display medium 150, such that the thermal-sensitive solution 152 becomes colloidal. The increase or decrease in the temperature of the display medium 150 is determined upon the characteristics of the thermal-sensitive solution 152, which is not limited in the present invention. As the temperature of the display medium 150 is raised and the micro particles 154 are confined in the colloidal thermal-sensitive solution 152, stability of displayed images on the display 100 can be effectively improved.

Additionally, in the present embodiment, the electric field generated by the first electrode 120 and the second electrode 140 not only results in the polarization and self-alignment of the micro particles 154 but also provides energy to raise the temperature of the display medium 150. That is to say, by means of the electric field generated by the first electrode 120 and the second electrode 140, the temperature of the display medium 150 can be adjusted, thus giving rise to a form change of the thermal-sensitive solution 152. In general, the display 100 affected by the electric field can achieve the display function, and the micro particles 154 can be fixed for stably displaying the images.

For instance, when the thermal-sensitive solution 152 is thermonegative, the thermal-sensitive solution 152 at a temperature higher than the threshold temperature is in the colloid form, while the thermal-sensitive solution 152 at a temperature lower than the threshold temperature is in the liquid form. To perform the display function on the display 100, the micro particles 154 are arranged first, and such arrangement is affected by the electric field that is generated by the first electrode 120 and the second electrode 140, for example. At this time, the electric field generated by the first electrode 120 and the second electrode 140 merely gives rise to the arrangement of the micro particles 154 without raising the temperature of the display medium 150 to be higher than the threshold temperature. Next, either energy or a frequency of the electric field is increased, so as to raise the temperature of the display medium 150 to be higher than the threshold temperature. At a temperature higher than the threshold temperature, the thermal-sensitive solution 152 becomes colloidal, and thereby the micro particles 154 remain immobile. As such, images displayed on the display 100 can be stabilized.

Certainly, the aforesaid steps of performing the display function on the display 100 are merely exemplary and should not be construed as limitations to the present invention. In other embodiments, the temperature of the display medium 150 can be adjusted by other ways, such that the thermal-sensitive solution 152 can be in different forms.

On the other hand, the structural design of the display 100 in the present embodiment only serves as an example of the present invention. According to other embodiments, the display medium 150 can be applied to micro-cup displays, capsule displays, or other electrophoretic displays. The display medium 150 is also applicable to various electronic paper display technologies for stabilizing display quality of the displays. Undoubtedly, the display 100 is designed to have a single type of micro particles 154, which is however not limited in the present invention. In other embodiments, micro particles 154 having different colors or different optical properties can be dispersed in the thermal-sensitive solution 152, so as to achieve a multi-color display effect.

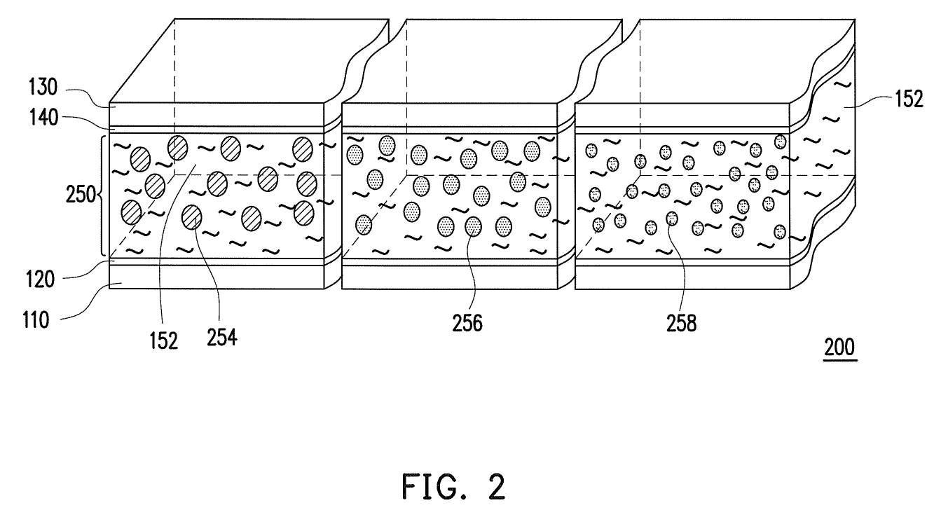

FIG. 2 is a display according to another embodiment of the present invention. Referring to FIG. 2, a display 200 is substantially identical to the display 100, and the same elements are represented by the same reference numbers. Therefore, no further descriptions are provided herein. It should be mentioned that a plurality of first-type micro particles 254, a plurality of second-type micro particles 256, and a plurality of third-type micro particles 258 in a display medium 250 of the display 200 are dispersed in the thermal-sensitive solution 152. Moreover, in the present embodiment, the first-type micro particles 254, the second-type micro particles 256, and the third-type micro particles 258 are, for example, red, green, and blue, respectively.

The first-type micro particles 254, the second-type micro particles 256, and the third-type micro particles 258 are, for example, affected by different electric fields and then polarized and self-aligned, respectively. For instance, a first electric field generated by the first electrode 120 and the second electrode 140 results in polarization and self-alignment of each of the first-type micro particles 254. A second electric field generated by the first electrode 120 and the second electrode 140 results in polarization and self-alignment of each of the second-type micro particles 256. A third electric field generated by the first electrode 120 and the second electrode 140 results in polarization and self-alignment of each of the third-type micro particles 258.

Practically, the first electric field, the second electric field, and the third electric field respectively have a first frequency, a second frequency, and a third frequency. The first frequency, the second frequency, and the third frequency differ from one another. In other words, the first-type micro particles 254, the second-type micro particles 256, and the third-type micro particles 258 can be polarized and self-aligned when affected by electric fields having different frequencies. In the present embodiment, the first-type micro particles 254, the second-type micro particles 256, and the third-type micro particles 258 can be arranged in a specific manner by adjusting the electric fields generated by the first electrode 120 and the second electrode 140. As such, color images can be displayed on the display 200.

When the color images are displayed on the display 200, the thermal-sensitive solution 152 is transformed from a liquid form to a colloid form, and thereby positions of the first-type micro particles 254, the second-type micro particles 256, and the third-type micro particles 258 are fixed, and image stability is enhanced. Certainly, the multi-color display effect is accomplished in the present invention without restricting the micro particles to be in red, green, and blue. In other embodiments, the micro particles having different optical properties can also be dispersed in the thermal-sensitive solution 152, so as to achieve the multi-color display effect.

In light of the foregoing, the thermal-sensitive solution of the display medium can be in different forms when the temperature changes according to the present invention. Accordingly, under certain circumstances, the display medium of the present invention can be in the colloid form, so as to fix the micro particles that are dispersed in the thermal-sensitive solution. When the aforesaid display medium is applied to the display, multi-stability of the display can be ensured. Namely, the display is able to stably display images.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display medium, comprising:
a thermal-sensitive solution; and
a plurality of micro particles, dispersed in the thermal-sensitive solution, wherein the thermal-sensitive solution is in a liquid form at a first temperature to allow the plurality of micro particles to move freely, the thermal-sensitive solution is in a colloid form at a second temperature to fix the plurality of micro particles, and the first temperature differs from the second temperature.

2. The display medium as claimed in claim 1, wherein the first temperature is higher than a threshold temperature, while the second temperature is lower than the threshold temperature.

3. The display medium as claimed in claim 1, wherein the first temperature is lower than a threshold temperature, while the second temperature is higher than the threshold temperature.

4. The display medium as claimed in claim 1, wherein an electric field results in polarization and self-alignment of the plurality of micro particles.

5. The display medium as claimed in claim 1, the plurality of micro particles comprising a plurality of first-type micro particles, a plurality of second-type micro particles, and a plurality of third-type micro particles, a first electric field resulting in polarization and self-alignment of each of the first-type micro particles, a second electric field resulting in polarization and self-alignment of each of the second-type micro particles, a third electric field resulting in polarization and self-alignment of each of the third-type micro particles.

6. The display medium as claimed in claim 5, wherein the first electric field, the second electric field, and the third electric field respectively have a first frequency, a second frequency, and a third frequency, and the first frequency, the second frequency, and the third frequency differ from one another.

7. The display medium as claimed in claim 5, wherein the plurality of first-type micro particles, the plurality of second-type micro particles, and the plurality of third-type micro particles respectively have different colors.

8. The display medium as claimed in claim 1, wherein a material of the thermal-sensitive solution comprises poly N-isopropyl acrylamide.

9. The display medium as claimed in claim 1, wherein the thermal-sensitive solution is transparent and colorless.

10. A display, comprising:
a first substrate;
a first electrode, disposed on the first substrate;
a second substrate;
a second electrode, disposed on the second substrate; and
a display medium, sandwiched between the first electrode and the second electrode and comprising:
a thermal-sensitive solution; and
a plurality of micro particles, dispersed in the thermal-sensitive solution, wherein the thermal-sensitive solution is in a liquid form at a first temperature to allow the plurality of micro particles to move freely, the thermal-sensitive solution is in a colloid form at a second temperature to fix the plurality of micro particles, and the first temperature differs from the second temperature.

11. The display as claimed in claim 10, wherein the first temperature is higher than a threshold temperature, while the second temperature is lower than the threshold temperature.

12. The display as claimed in claim 10, wherein the first temperature is lower than a threshold temperature, while the second temperature is higher than the threshold temperature.

13. The display as claimed in claim 10, wherein an electric field generated by the first electrode and the second electrode results in polarization and self-alignment of the plurality of micro particles.

14. The display as claimed in claim 10, the plurality of micro particles comprising a plurality of first-type micro particles, a plurality of second-type micro particles, and a plurality of third-type micro particles, a first electric field generated by the first electrode and the second electrode resulting in polarization and self-alignment of each of the first-type micro particles, a second electric field generated by the first electrode and the second electrode resulting in polarization and self-alignment of each of the second-type micro particles, a third electric field generated by the first electrode and the second electrode resulting in polarization and self-alignment of each of the third-type micro particles.

15. The display as claimed in claim 14, wherein the first electric field, the second electric field, and the third electric field respectively have a first frequency, a second frequency, and a third frequency, and the first frequency, the second frequency, and the third frequency differ from one another.

16. The display as claimed in claim 14, wherein the plurality of first-type micro particles, the plurality of second-type micro particles, and the plurality of third-type micro particles respectively have different colors.

17. The display as claimed in claim 10, wherein a material of the thermal-sensitive solution comprises poly N-isopropyl acrylamide.

18. The display as claimed in claim 10, wherein the thermal-sensitive solution is transparent and colorless.

19. The display as claimed in claim 10, wherein the first electrode is a reflective electrode.

20. The display as claimed in claim 10, wherein the second electrode is a transparent electrode.

21. The display as claimed in claim 10, wherein the plurality of micro particles comprises metal particles.

22. The display as claimed in claim 10, wherein the plurality of micro particles comprises polymer particles.

23. The display as claimed in claim 22, wherein a material of the plurality of micro particles comprises polystyrene particles.

24. The display as claimed in claim 22, wherein a material of the plurality of micro particles comprises polyethylene particles.
